(19) United States
(12) Patent Application Publication
(10) Pub. No.: US 2015/0263547 A1
(43) Pub. Date: Sep. 17, 2015

(54) Apparatus for Charging Mobile Devices

(71) Applicant: Marcel Browne, Albuquerque, NM (US)

(72) Inventor: Marcel Browne, Albuquerque, NM (US)

(21) Appl. No.: 14/208,066

(22) Filed: Mar. 13, 2014

(51) Int. Cl. H02J 7/00

(52) U.S. Cl. CPC H02J 7/0027; H02J 7/0052; H02J 7/0054; H02J 7/0044

(57) ABSTRACT

An apparatus comprises a central tower structure comprising sides, a top and a bottom. The central tower is configured for enclosing a power source configured for at least charging a plurality of mobile electronic devices. The central tower structure is further configured for resting in an upright position on a surface. Arm structures are joined to the central tower structure. The arm structures are rotatable from a closed position, in which the arm structures rest against the sides, to an open position, in which the arm structures rest on the surface. The arm structures comprise docking portions for accepting the mobile electronic devices. Device interfaces are associated with the docking portions. The device interfaces are configured for communicating with the mobile electronic devices for at least transferring power from the power source to the mobile electronic devices.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to devices having deployable arms. More particularly, the invention relates to devices having deployable arms allowing interaction with other devices.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Some users of electronic devices may seek an efficient, useful means of stowing, charging, holding, and otherwise using electronic and/or non-electronic devices.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. One such aspect of the prior art shows a charger with two or more separate charging ports to which two or more rechargeable batteries can be coupled. By way of educational background, another aspect of the prior art generally useful to be aware of teaches of a power supply for charging multiple devices that can be adapted to receive and charge practically any type of portable electronic device including a base that receives an AC wall voltage and converts the wall voltage to DC voltage. Yet another such aspect of the prior art discloses of a charging station for wireless digitizer tablets including a housing and a plurality of tablet receiving areas associated with the housing. However, these solutions may not provide a compact, efficient means for stowing, charging, holding, and otherwise using electronic devices. A solution which did so would be desirable.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of a mechanism for storing, charging, holding, and/or otherwise using electronic and/or non-electronic devices, in accordance with an embodiment of the present invention;

FIG. 2 is an illustration of an exemplary embodiment device holding multiple portable devices, in accordance with an embodiment of the present invention;

FIG. 3 is an illustration of another view of an exemplary embodiment device, in accordance with an embodiment of the present invention;

FIG. 4 is an illustration of an above view of an exemplary embodiment device with four moveable arms in a deployed position, in accordance with an embodiment of the present invention;

FIG. 5 is an illustration of multiple views of an exemplary embodiment device with all moveable arms in a stowed position, in accordance with an embodiment of the present invention; and

FIG. 6 is an illustration of a mechanism for storing, charging, holding, and/or otherwise using electronic and/or non-electronic devices, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Some embodiments of the present invention may provide means and/or methods for storing, charging, holding, and/or otherwise using electronic and/or non-electronic devices.

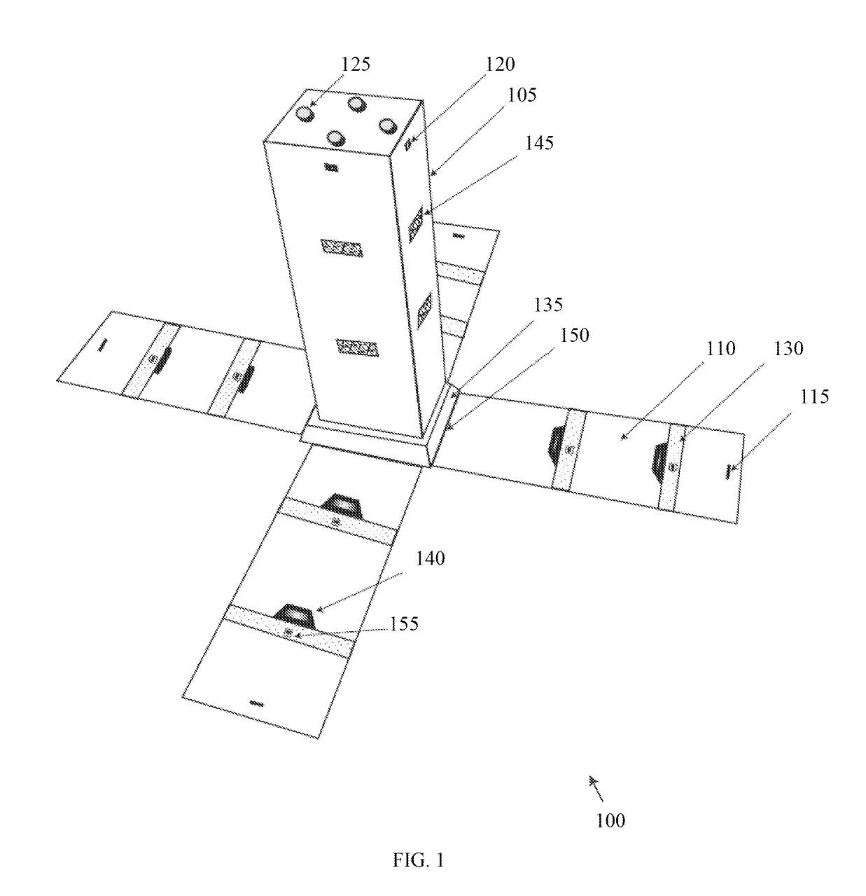

FIG. 1 is an illustration of a mechanism for storing, charging, holding, and/or otherwise using electronic and/or non-electronic devices. In the present embodiment, a central housing tower 105 may provide a central structure. In some embodiments, central housing tower 105 may contain one or more power sources. In some of these embodiments, power source may comprise one or more rechargeable batteries. In a non-limiting example, a power source may comprise a rechargeable lithium ion battery. In alternative embodiments, a power source may comprise replaceable batteries. In some embodiments, a central housing tower 105 may have a rectangular cuboid shape with four sides. In alternative embodiments, a central housing tower 105 may have any shape and/or any number of sides. In a non-limiting example, a central housing tower 105 may have a shape of a triangular prism, hexagonal prism, or pyramid. In the present embodiment, one or more moveable arms 110 may extend from central housing tower 105. In some embodiments, the one or more movable arms 110 may be sized and/or shaped to match a side of the central housing tower 105. In alternative embodiments, movable arms 110 may have any size and/or shape. In the present embodiment, movable arms 110 may have one or more arm fasteners 115. In some embodiments, arm fasteners 115 may provide a means of attaching movable arms 110 to central housing tower 105. In the present embodiment, central housing tower 105 may have one or more arm fastener closures 120. In some embodiments, an arm fastener closure 120 may attach to an arm fastener 115 to hold a moveable arm 110 in place. In some embodiments, a user may have means for releasing arm fastener closure 120 to allow moveable arm 110 to move freely. In the present embodiment, a release mechanism 125 may be situated on the central housing tower 105. In some embodiments, individual arm fastener closures 120 may be controlled by individual release mechanisms 125. In alternative embodiments, a release mechanism 125 may control multiple arm fastener closures 120. In the present embodiment, moveable arm 110 may have one or more grooves 130. In some embodiments, grooves 130 may be suitable to receive and/or hold a device. In the present embodiment, central housing tower 105 may have a base 135. In some embodiments, base 135 may have a suitable size and/or shape to support central housing tower 105 in an upright position. In some of these embodiments, base may be composed of a heavy material to provide balance to the central housing tower 105. In the present embodiment, movable arms 110 may have one or more portable device supports 140. In some embodiments, portable device supports 140 may extend from movable arms 110 to provide support to devices which may be situated in grooves 130. In many embodiments, a portable device support 140 may be situated proximally to each groove 130. In the present embodiment, central housing tower 105 may one or more support closures 145. In some embodiments, support closures 145 may be sized and/or shaped to receive portable device supports 140 when moveable arms 110 may be attached to central housing tower 105. In the present embodiment, moveable arms 110 may attach to central housing tower 105 by means of a joint/hinge 150. In some embodiments, joint/hinge 150 may attach to base 135. In other embodiments, joint/hinge 150 may attach to any portion of central housing tower 105. In the present embodiment, moveable arms 110 may have one or more portable device interfaces 155. In some embodiments, portable device interfaces 155 may be situated in grooves 130. In many embodiments, portable device interfaces 155 may be suitable for connecting to a portable device. In a non-limiting example, portable device interface 155 may be an electrical charger which may be suitable to connect to a charging hub of an electronic device. In another non-limiting example, portable device interface 155 may be a USB connector which may be suitable to connect to a USB hub of an electronic device. In another non-limiting example, portable device interface 155 may be any multi-pin connector configured for interfacing with a portable device.

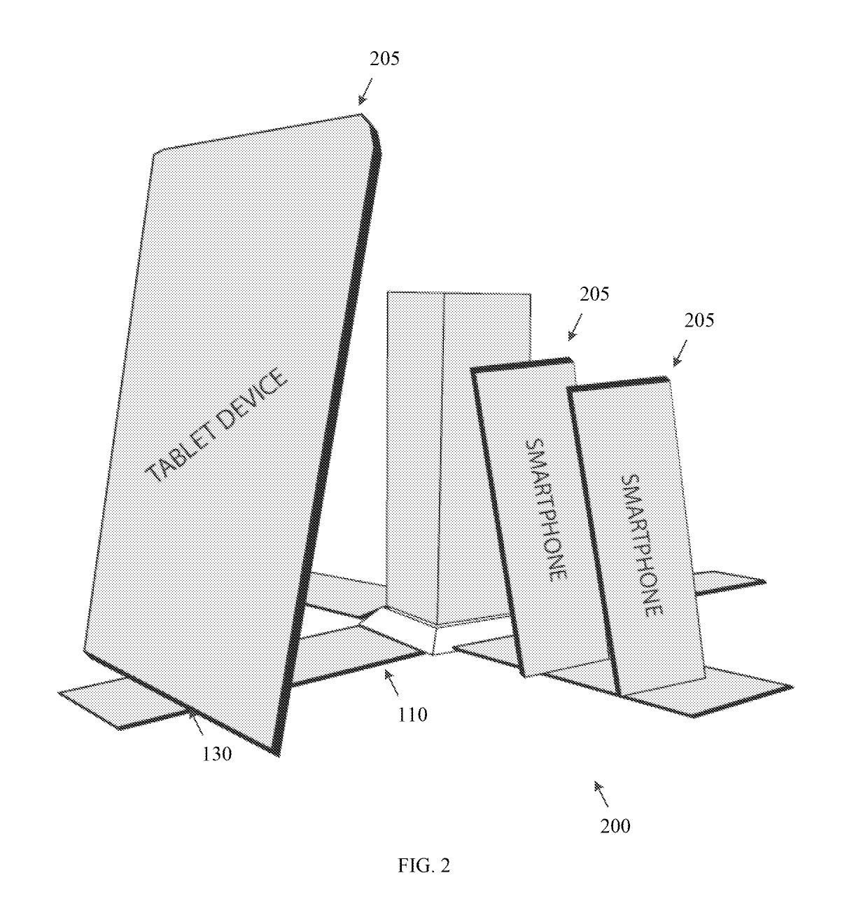

FIG. 2 is an illustration of an exemplary embodiment device holding multiple portable devices, in accordance with an embodiment of the present invention. In the present embodiment, moveable arms 110 may hold multiple types of devices 205. In some embodiments, moveable arms 110 may hold many various types of electronic and/or non-electronic devices 205, including, without limitation, smartphones, tablets, iPods, text books, individual pieces of paper, clipboards, etc. In one or more embodiments, grooves 130 of moveable arms may be designed to hold one or more specific types of devices. In alternative embodiments, grooves 130 may be adjusted in size and/or shape by users to accommodate different types of devices. In a non-limiting example, a groove 130 sized to fit a thin smartphone may be stretched to accommodate a larger smartphone by sliding groove 130 edges apart. In some of these alternative embodiments, users may adjust size and/or shape of grooves 130 to clamp a device in position. In a non-limiting example, a user may slide groove 130 edges together to clamp a text book to hold it upright. In other alternative embodiments, grooves 130 may be able to accommodate multiple types and/or sizes of devices. Some embodiments may have grooves that can adapt to either the shape or size of the device or case surrounding the devices. In other alternative embodiments, portable device interfaces 155 may be interchangeable. In a non-limiting example, a user may change a USB connecter to an electrical charger. In some of these alternative embodiments, users may open moveable arms 110 to adjust components of arms 110.

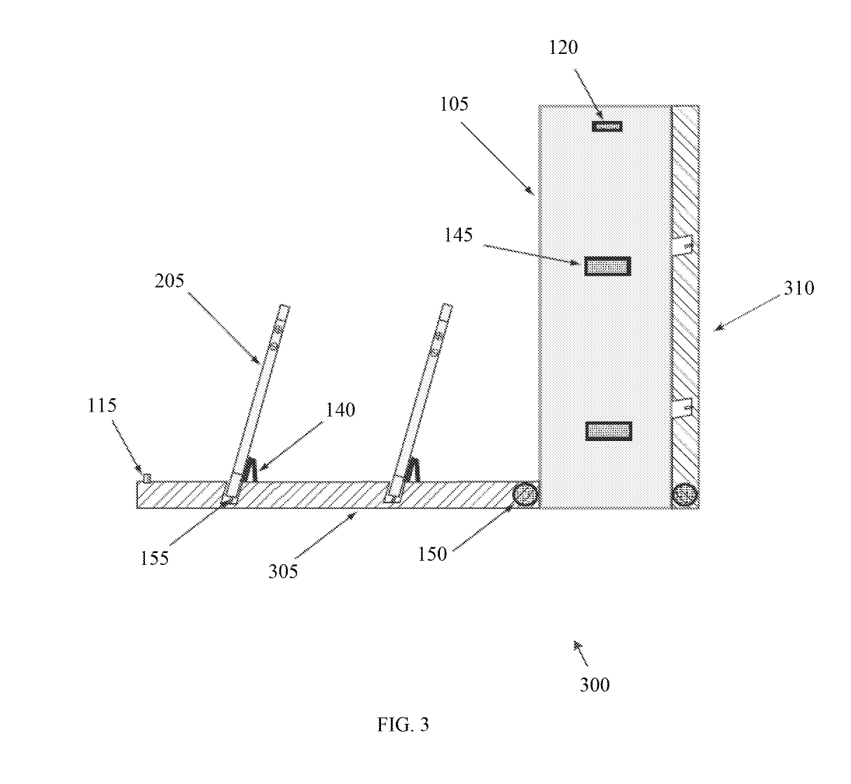

FIG. 3 is an illustration of another view of an exemplary embodiment device, in accordance with an embodiment of the present invention. In the present embodiment, a first moveable arm 305 may be in a deployed position while a second moveable arm 310 may be in a stowed position.

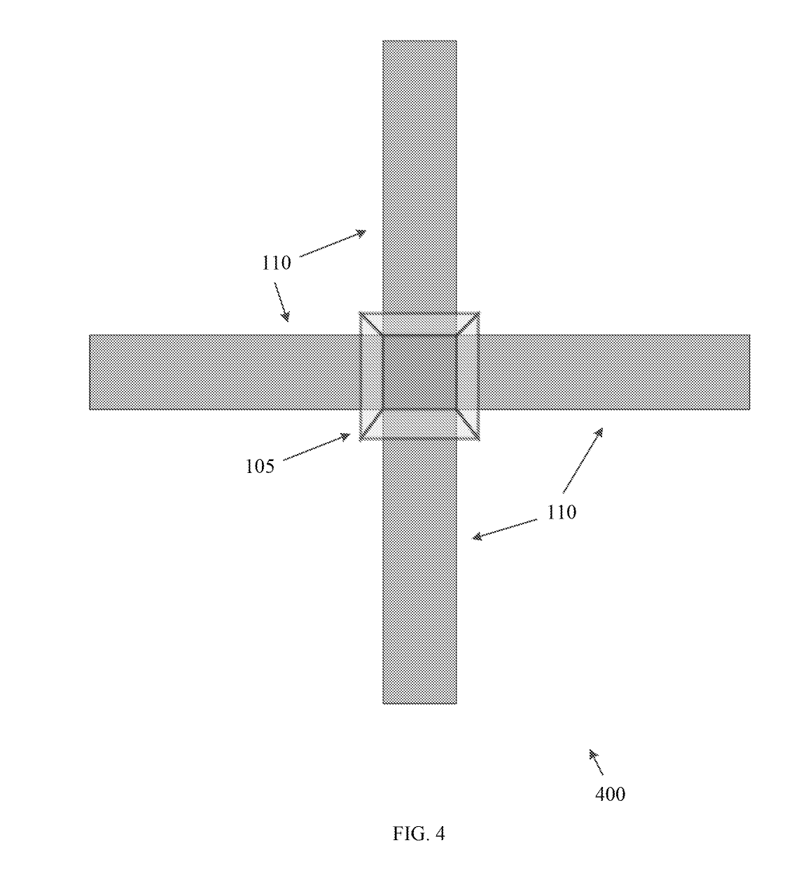

FIG. 4 is an illustration of an above view of an exemplary embodiment device with four moveable arms in a deployed position, in accordance with an embodiment of the present invention.

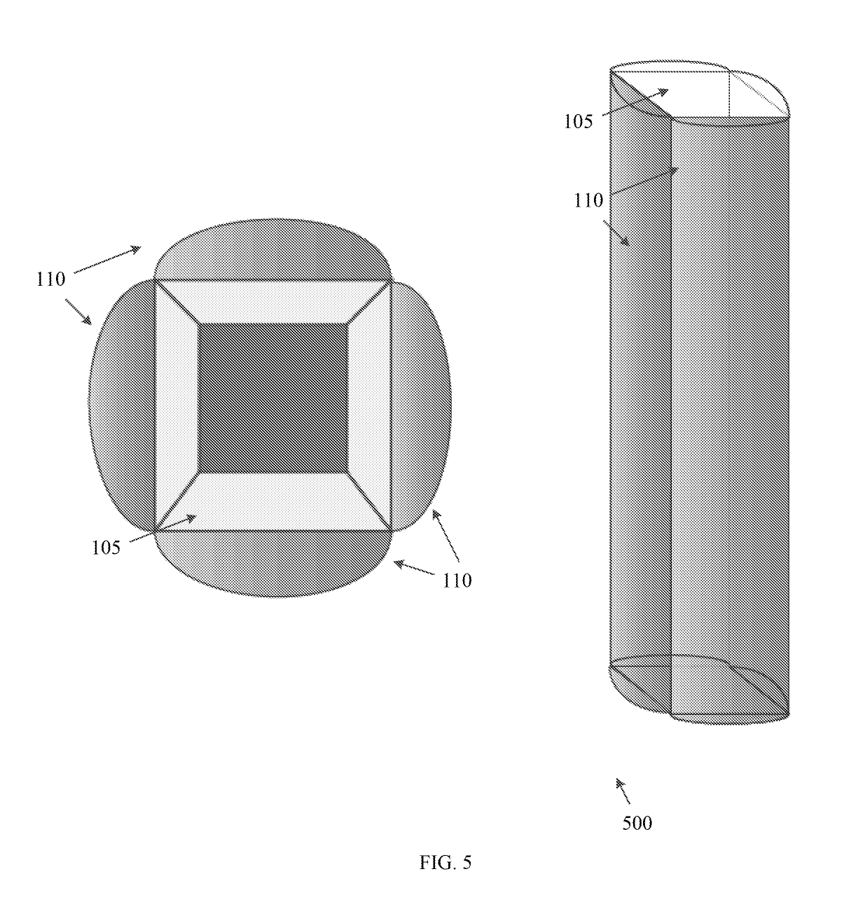

FIG. 5 is an illustration of multiple views of an exemplary embodiment device with all moveable arms in a stowed position, in accordance with an embodiment of the present invention.

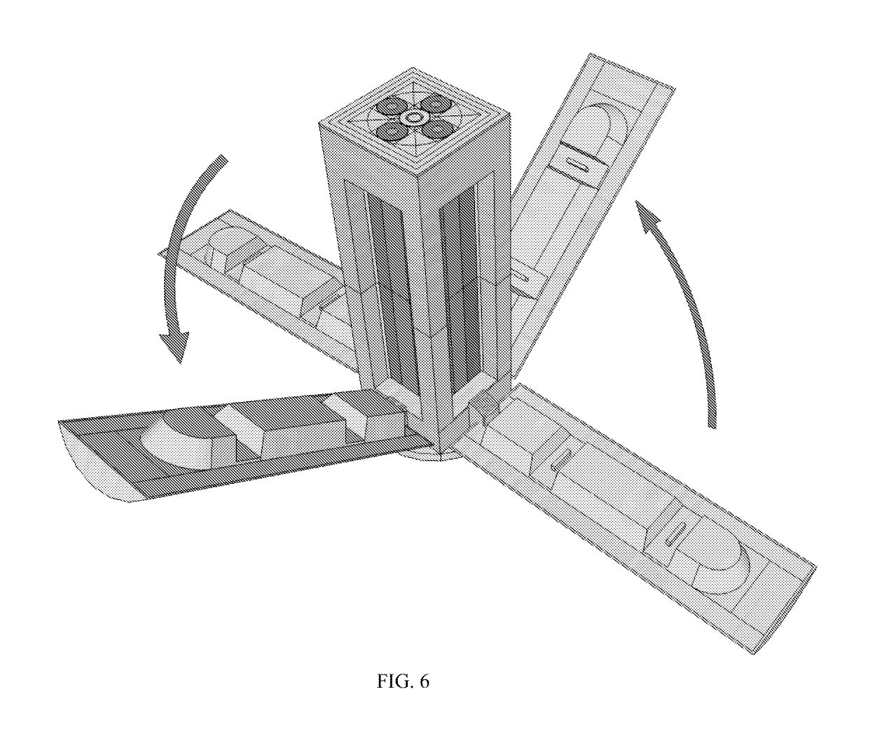

FIG. 6 is an illustration of a mechanism for storing, charging, holding, and/or otherwise using electronic and/or non-electronic devices, in accordance with an embodiment of the present invention. The present embodiment illustrates an alternate embodiment to that shown in FIG. 1. In the present embodiment, the grooves for holding the devices are formed in raised structures and are larger and deeper than the embodiment of FIG. 1. These larger and deeper grooves may provide a suitable support for the portable devices in which additional portable device supports may not be needed. In the present embodiment, the central housing tower includes recessed areas on the sides to accommodate the raised structures when the arms are in the closed position.

Those skilled in the art will recognize that embodiment devices may take other forms than those described. In many instances, embodiment devices may have various sizes and/or shapes. As such, embodiment devices illustrated in FIGS. 1-6 may take forms other than that shown in FIGS. 1-6.

In some embodiments, a power source within embodiment device may be suitable to charge multiple electronic devices simultaneously. In at least one embodiment, embodiment device may have a cord which may plug into an external power source. In some of these embodiments, the cord may be retractable.

Some embodiments may allow moveable arms 110 to attach to central housing tower 105 to provide a compact device which a user may effectively carry and/or store. In alternative embodiments, arms 110 may not be moveable. In other alternative embodiments, components of embodiment device may provide for easier carrying by users. In a non-limiting example, a moveable arm 110 may have a retractable handle on an outer side which a user may pull out to carry an embodiment device while moveable arm 110 is stowed (i.e. attached to central housing tower 105).

In some alternative embodiments, embodiment device may have one or more lights. In a non-limiting example, a moveable arm 110 may have a light situated to provide illumination to a device held by the moveable arm 110. In some of these alternative embodiments, individual lights may have individual on/off switches.

Some embodiments may be structurally flexible to allow for comfortable and/or durable storage. In some embodiments, embodiment device may be more space efficient when arms 110 are in a stowed position than in a deployed position. Some embodiments may be manipulated by users to form a functional stand. In some of these embodiments, deploying arms 110 may not involve assembly by users, as movement of arms 110 may be guided by other components, such as joints 150.

In some embodiments, some components may be incorporated into other devices. In a non-limiting example, a central housing tower 105 may serve as a body of a tableside lamp while still having functionality in an embodiment device.

In some alternative embodiments, arms 110 may have intrinsic means for interactive activity. In a non-limiting example, arms 110 may have electronic tablets built in. In some alternative embodiments, arms 110 and central housing tower 105 may include independent USB ports for connection to other devices. In some other alternative embodiments, the base 135 may be configured for retaining a typical voltage converter for storage.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing devices having deployable arms according to the present invention will be apparent to those skilled in the art. Various aspects of the invention have been described above by way of illustration, and the specific embodiments disclosed are not intended to limit the invention to the particular forms disclosed. The particular implementation of the devices having deployable arms may vary depending upon the particular context or application. By way of example, and not limitation, the devices having deployable arms described in the foregoing were principally directed to multi-device interaction implementations; however, similar techniques may instead be applied to devices having deployable arms with intrinsic devices, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a central tower structure comprising a plurality of sides, a top and a bottom, said central tower being configured for enclosing a power source configured for at least charging a plurality of mobile electronic devices, said central tower structure being further configured for resting in an upright position on a surface;
one or more arm structures being joined to said central tower structure, said arm structures being rotatable from a closed position, in which said arm structures rest against the sides, to an open position, in which said arm structures rest on the surface, said arm structures comprising one or more docking portions configured for accepting the mobile electronic devices; and
one or more device interfaces being associated with said one or more docking portions, said one or more device interfaces being configured for communicating with the mobile electronic devices for at least transferring power from the power source to the mobile electronic devices.

2. The apparatus as recited in claim 1, further comprising a base structure joined to said bottom.

3. The apparatus as recited in claim 1, further comprising one or more hinges being configured for joining said one or more arm structures to said central tower structure.

4. The apparatus as recited in claim 1, further comprising one or more closure mechanisms being configured for retaining said one or more arms in said closed position.

5. The apparatus as recited in claim 4, further comprising one or more release mechanisms being configured for releasing said one or more closure mechanisms.

6. The apparatus as recited in claim 1, further comprising one or more device supports disposed proximate said one or more docking portions for supporting the mobile electronic devices.

7. The apparatus as recited in claim 1, in which said one or more docking portions comprise grooves being configured to accept the mobile electronic devices.

8. The apparatus as recited in claim 7, in which said one or more device interfaces are disposed within said grooves.

9. The apparatus as recited in claim 6, in which said central tower structure further comprises at least one support closure being configured for receiving said one or more device supports with said one or more arm structures in said closed position.

10. The apparatus as recited in claim 1, in which the power source comprises a battery.

11. The apparatus as recited in claim 1, in which said central tower structure comprises four sides.

12. The apparatus as recited in claim 11, in which the apparatus comprises four arm structures.

13. The apparatus as recited in claim 12, in which said four arm structures present a curved outer surface in said closed position.

14. An apparatus comprising:
means for enclosing a power source configured for at least charging a plurality of mobile electronic devices;
means for accepting the mobile electronic devices, said accepting means being joined to said enclosing means and being rotatable from a closed position, in which said accepting means rests against said enclosing means, to an open position, in which said accepting means rests on a surface; and
means for communicating with the mobile electronic devices for at least transferring power from the power source to the mobile electronic devices.

15. The apparatus as recited in claim 14, further means for supporting said enclosing means on the surface.

16. The apparatus as recited in claim 14, further comprising means for joining said accepting means to said enclosing means.

17. The apparatus as recited in claim 14, further comprising means for retaining said accepting means in said closed position.

18. The apparatus as recited in claim 17, further comprising means for releasing retaining means.

19. The apparatus as recited in claim 14, further comprising means for supporting the mobile electronic devices.

20. An apparatus comprising:
a central tower structure comprising four sides, a top and a bottom, said central tower being configured for enclosing a power source comprising a battery configured for at least charging a plurality of mobile electronic devices, said central tower structure being further configured for resting in an upright position on a surface;
a base structure joined to said bottom for supporting said central tower structure on the surface;
four arm structures being joined to said central tower structure, said arm structures being rotatable from a closed position, in which said arm structures rest against the sides, to an open position, in which said arm structures rest on the surface, said four arm structures presenting a curved outer surface in said closed position, said arm structures comprising one or more docking portions configured for accepting the mobile electronic devices, said one or more docking portions comprising grooves being configured to accept the mobile electronic devices;
one or more device supports disposed proximate said one or more docking portions for supporting the mobile electronic devices, said central tower structure further comprising at least one support closure being configured for receiving said one or more device supports with said four arm structures in said closed position;
four hinges being configured for joining said four arm structures to said central tower structure;
four closure mechanisms being configured for retaining said four arms in said closed position;
four release mechanisms being configured for releasing said four closure mechanisms; and
one or more device interfaces being associated with said one or more docking portions, said one or more device interfaces being disposed within said grooves, said one or more device interfaces being configured for communicating with the mobile electronic devices for at least transferring power from the power source to the mobile electronic devices.
